(19) United States
(12) Patent Application Publication
(10) Pub. No.: US 2007/0130776 A1
(43) Pub. Date: Jun. 14, 2007

(54) Shear with replaceable shearing tip

(76) Inventors: Patrick Grant, Tilburg (NL); John van Gemert, Mill (NL)

Correspondence Address: CATERPILLAR/FINNEGAN, HENDERSON, L.L.P., 901 New York Avenue, NW, WASHINGTON, DC, 20001-4413, US

(21) Appl. No.: 11/301,818

(22) Filed: Dec. 12, 2005

(51) Int. Cl. B25F 3/00

(52) U.S. Cl. 30/134

(57) ABSTRACT

A replaceable shearing tip is provided for using with a shear, the shear having a lower jaw and an upper jaw pivotally connected to the lower jaw, the upper jaw having a left portion, a right portion, and a front portion between the left portion and the right portion. The replaceable shearing tip has a left part having two edges, a mounting section extending between the two edges for mounting the left part on the upper jaw, and a front section connected to the mounting section for covering the front portion of the upper jaw. The replaceable shearing tip further has a right part, wherein the left part and the right part are interchangeable.

### TECHNICAL FIELD

The present disclosure is directed to a shear, and more particularly, to a heavy duty shear having a replaceable shearing tip.

### BACKGROUND

A conventional heavy duty shear typically employs relative movable upper and lower jaws with shear blades of hardened steel on both the upper jaw and the lower jaw. The distal end of the jaw members is provided with a cutting and piercing tip by which a workpiece is pierced and severed during closure of the one jaw member relative to the other. Such jaw tips are subject to extreme wear and accordingly require frequent replacement. Replacement of the tips is expensive both from the standpoint of the cost of the tip and the down time required to remove, repair and reconnect a damaged or worn tip or, if beyond repair, to replace with a new tip component. Accordingly, repairing or replacement of the tip is required each time the piercing and cutting edges become worn or damaged, whereby maintenance costs and down time are undesirably high.

In addition, high lateral forces are exerted on the tip, great tension is also exerted upon the tip, and direct shear bearing loads are also applied to the tip when shearing. All these factors will cause a removable tip to easily break off the upper jaw.

U.S. Patent Publication No. 2004/0093739 provides a shear having a replaceable shearing tip. The shearing tip of 2004/0093739 only has one cutting edge, and therefore, the shearing tip has to be replaced once this single cutting edge is worn. In addition, the shearing tip of 2004/0093739 is mounted to the upper jaw by screws, and those screws may easily break off the upper jaw.

The shear with a replaceable shearing tip of the present disclosure solves one or more of the problems set forth above.

### SUMMARY OF THE INVENTION

In one aspect, the present disclosure is directed to a replaceable shearing tip for using with a shear. The shear has a fixed lower jaw and a movable upper jaw pivotally connected to the lower jaw. The upper jaw has a left portion, a right portion, a front portion between the left portion and the right portion, and a replaceable shearing tip mounted on the upper jaw. The replaceable shearing tip includes a left part having two edges, a mounting section extending between the two edges for mounting the left part on the left portion of the upper jaw, and a front section connected to the mounting section for covering the front portion of the upper jaw. The shearing tip also includes a right part having two edges, a mounting section extending between the two edges for mounting the right part of the shearing tip on the right portion of the upper jaw, and a front section connected to the mounting section for covering the front portion of the upper jaw. The left part and the right part are interchangeable. In one embodiment, the left part and the right part are substantially identical. In one embodiment, the two edges of the left part are symmetrical, and the two edges of the right part are symmetrical.

In one aspect, the present disclosure is directed to a method of replacing a shearing tip on an upperjaw of a shear. The upper jaw has a right portion, a left portion, and a front portion between the right portion and the left portion. The method includes disassembling a right part of the shearing tip from the right portion of the upper jaw, and disassembling a left part of the shearing tip from the left portion of the upper jaw. The method also includes mounting the right part of the shearing tip to the left portion of the upper jaw, and mounting the left part of the shearing tip to the right portion of the upper jaw.

### BRIEF DESCRIPTION OF THE DRAWINGS

FIG. 1 is a diagrammatic illustration of an exemplary disclosed shear;

FIG. 2 is an exploded view of an upper jaw of the shear of FIG. 1;

FIG. 3 is an exploded view of the shearing tip of FIG. 2;

FIG. 4 is a diagrammatic illustration of an exemplary disclosed shearing tip of the upper jaw; and

FIG. 5 is a diagrammatic view of one part of the disclosed shearing tip.

### DETAILED DESCRIPTION

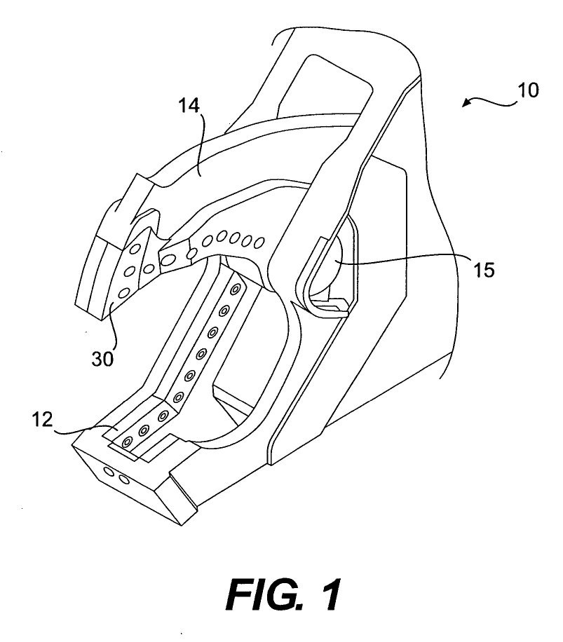

FIG. 1 illustrates an exemplary shear 10. The shear 10 may be a metal demolition shear or a scrap shear. The shear may be attached to the boom structure of, for example, excavating or earth-moving excavation equipment. The shear 10 comprises a fixed or stationary lower jaw 12, a movable upper jaw 14, and a pivot 15 pivotally connecting the lower jaw 12 and the upper jaw 14.

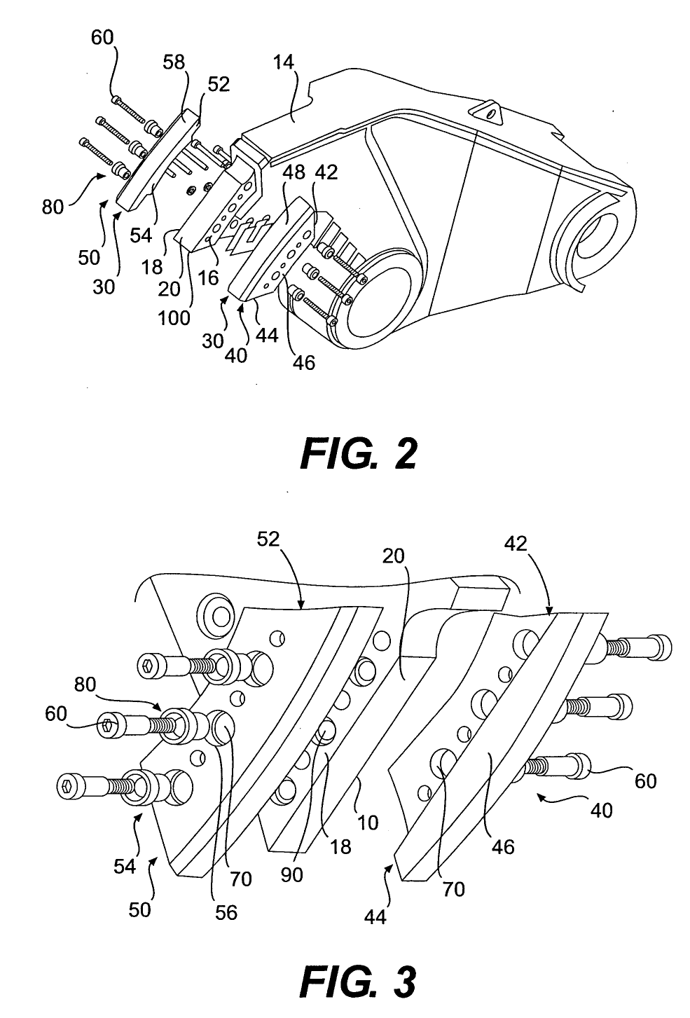

FIGS. 2 and 3 illustrate an exemplary replaceable shearing tip 30 for using with the shear 10. The upper jaw 14 has a left portion 16, a right portion 18, and a front portion 20 between the left portion 16 and the right portion 18. The replaceable shearing tip 30 has a left part 40 and a right part 50. The right part 50 and the left part 40 are interchangeable. In one embodiment, the left part 40 and the right part 50 are substantially identical. The left part 40 has two symmetrical edges including an upper edge 42 and a lower edge 44, a mounting section 46 extending between the two symmetrical edges 42 and 44 for mounting the left part 40 on the left portion 16 of the upper jaw 14, and a front section 48 connected to the mounting section 46 for covering the front portion 20 of the upper jaw 14. In one embodiment, the front section 48 and the mounting section 46 of the left part 40 are connected in a substantial L-shape. The right part 50 also has two symmetrical edges including an upper edge 52 and a lower edge 54, a mounting section 56 extending between the two symmetrical edges 52 and 54 for mounting the right part 50 on the right portion 18 of the upper jaw 14, and a front section 58 connected to the mounting section 56 for covering the front portion 20 of the upper jaw 14. In one embodiment, the front section 58 and the mounting section 56 of the right part 50 are connected in a substantial L-shape.

As shown in FIG. 3, the left part 40 and the right part 50 of the replaceable shearing tip 30 are mounted to the upper jaw 14 by a plurality of bolts 60. Each bolt 60 has screw threads at a front portion of the bolt. The left part 40 and the right part 50 define holes 70 for receiving the bolts 60. The left portion 16 and the right portion 18 of the upper jaw 14 also define holes 90 in the upper jaw 14 with screw threads on inner surfaces for engaging the screw threads on the front portion of the bolts 60. In one embodiment, each bolt 60 is provided with an associated bush 80. The bush 80 is received in the hole 70 of the tip 30, and the front portion of the bolt 60 passes through the respective bush 80 and the hole 70 of the tip 30, and is secured in the hole 90 of the upper jaw 14. In another embodiment as shown in FIG. 5, the bushes 80′ are integrated with the left part 40 and right part 50 of the replaceable shearing tip 30. The bushes increase the “shearing area” between the bolts and the upper jaw, and therefore help to prevent the bolts from shearing.

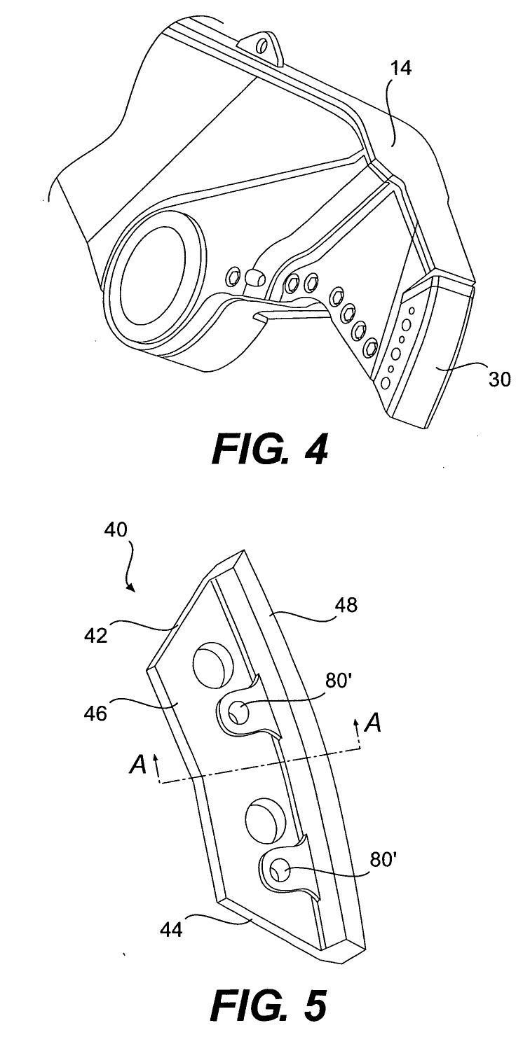

As shown in FIGS. 1 and 4, the replaceable shearing tip 30 is mounted on the upper jaw 14. In one embodiment as shown in FIG. 2, the front section 48 of the left part 40 and the front section 58 of the right part 50 together cover an entire surface of the front portion 20 of the upper jaw 14. In another embodiment as shown in FIG. 4, the front section 48 of the left part 40 is integrated with the front section 58 of the right part 50 to form a unitary shearing tip 30. In use, the unitary front section of the shearing tip 30 covers the entire surface of the front portion of the upper jaw 14. After the lower edge of the shearing tip 30 is worn, the shearing tip 30 can then be retrieved from the upper jaw 14, turned around and installed to the upper jaw 14 in a reversed position.

An example of the left part 40 or the right part 50 is shown in FIG. 5. Because the left part 40 and the right part 50 of the shearing tip 30 are interchangeable (e.g., substantially identical), the part in FIG. 5 is described as a left part 40, but it also can be a right part 50. As shown in FIG. 5, the front section 48 of the left part 40 and the mounting section 46 of the left part 40 are connected in a substantial L-shape. The upper edge 42 and the lower edge 44 of the left part 40 are mirror-image symmetrical with respect to a central plane A-A of the left part 40.

The replaceable shearing tip 30 may be made of a hard metal, for example, hardened steel.

### INDUSTRIAL APPLICABILITY

The disclosed replaceable shearing tip may be applicable to any shear that includes demolition shears and scrap shears. The operation of the replaceable shearing tip will now be explained.

The shearing tip 30 has two interchangeable parts including a left part 40 and a right part 50. In one embodiment, the left part 40 and the right part 50 are substantially identical. The left part 40 has two symmetrical cutting edges including an upper edge 42 and a lower edge 44. The right part 50 has two symmetrical cutting edges including an upper edge 52 and a lower edge 54. The tip 30 is mounted on the upper jaw 14. The lower edges 44 and 54, which are mounted at a distal end 100 of the upper jaw, may be worn after a period of time of use. The left part 40 and the right part 50 of the tip 30 can be disassembled from the upper jaw 14. The left part 40 of the shearing tip 30 can be turned upside down and installed on the right portion 18 of the upper jaw 14 in a reversed position. In other words, the left part 40 of the shearing tip 30 may be installed to the right portion 18 of the upper jaw 14 with the lower edge 44 in a proximal position and the upper edge 42 at the distal end 100 of the upper jaw 14. Similarly, the right part 50 also can be turned around and installed on the left portion 16 of the upper jaw 14 in a reversed position. Thereby, the upper edges 42 and 52 at the distal end 100 of the upper jaw 14 can be used for another period of time before the shearing tip 30 is worn out and needs to be replaced by a new shearing tip.

Several advantages over the prior art may be associated with the disclosed replaceable shearing tip 30. The tip 30 is mounted to the upper jaw 14 by bolts 60, and therefore, the tip 30 can be easily mounted on and dissembled from the upper jaw 14. The replaced shearing tip 30 further has bushes 80, and the bolts 60 are received in the bushes 80, which lock the tip 30 to the upper jaw 14, and prevent the tip 30 from breaking off the upper jaw 14 despite high direct and lateral forces, as well as shearing and tensional forces exerted on the tip 30. The tip 30 also covers the complete front portion 20 of the upper jaw 14, and therefore, protects the front portion 20 of the upper jaw 14 from wearing. The tip 30 includes two interchangeable parts 40 and 50, each having two symmetrical cutting edges. After a first set of edges is worn, the two interchangeable parts 40 and 50 can be turned around and installed on the other side of the upper jaw 14 in a reversed position, so that a second set of edges can be used. Therefore, the tip can be used twice and has a longer life time.

It will be apparent to those skilled in the art that various modifications and variations can be made to the shear with replaceable shearing tip. Other embodiments will be apparent to those skilled in the art from consideration of the specification and practice of the disclosed shear with replaceable shearing tip. It is intended that the specification and examples be considered as exemplary only, with a true scope being indicated by the following claims and their equivalents.

What is claimed is:

1. A replaceable shearing tip for using with a shear, the shear having a lower jaw and an upper jaw pivotally connected to the lower jaw, the upper jaw having a left portion, a right portion, and a front portion between the left portion and the right portion, the replaceable shearing tip comprising:
a left part having two edges, a mounting section extending between the two edges for mounting the left part on the upper jaw and a front section connected to the mounting section for covering the front portion of the upper jaw; and
a right part having two edges, a mounting section extending between the two edges for mounting the right part on the upper jaw, and a front section connected to the mounting section for covering the front portion of the upper jaw,
wherein the left part and the right part are interchangeable.

2. The replaceable shearing tip of claim 1, wherein the left part and the right part are substantially identical.

3. The replaceable shearing tip of claim 1, wherein the two edges of the left part are symmetrical, and the two edges of the right part are symmetrical.

4. The replaceable shearing tip of claim 1, wherein the front section of the right part and the front section of the left part together cover an entire surface of the front portion of the upper jaw.

5. The replaceable shearing tip of claim 1, wherein the front section of the right part is integrated with the front section of the left part.

6. The replaceable shearing tip of claim 1, wherein the left part and the right part of the replaceable shearing tip are mounted to the upper jaw by a plurality of bolts.

7. The replaceable shearing tip of claim 6, wherein the left part and the right part include holes for receiving the bolts, and the replaceable shearing tip further includes bushes received in the respective holes and the bolts are received in the respective bushes.

8. The replaceable shearing tip of claim 7, wherein the bushes are integrated with the left part and right part of the replaceable shearing tip.

9. The replaceable shearing tip of claim 1, wherein the front section of the left part and the mounting section of the left part are connected in a substantial L-shape, and wherein the front section of the right part and the mounting section of the right part are connected in a substantial L-shape.

10. A method of replacing a shearing tip on an upper jaw of a shear, the upper jaw having a right portion, a left portion, and a front portion between the right portion and the left portion, the method comprising:
disassembling a right part of the shearing tip from the right portion of the upper jaw;
disassembling a left part of the shearing tip from the left portion of the upper jaw;
mounting the right part of the shearing tip to the left portion of the upperjaw; and
mounting the left part of the shearing tip to the right portion of the upper jaw.

11. The method of claim 10, wherein the left part and the right part of the replaceable shearing tip are interchangeable.

12. The method of claim 10, wherein the left part and the right part of the replaceable shearing tip are substantially identical.

13. The method of claim 10, wherein the left part and the right part each have two symmetrical edges.

14. The method of claim 10, wherein
mounting the left part of the shearing tip to the right portion of the upper jaw includes mounting the left part of the shearing tip to the right portion of the upper jaw in a reverse position,
and mounting the right part of the shearing tip to the left portion of the upper jaw includes mounting the right part of the shearing tip to the left portion of the upper jaw in a reverse position.

15. The method of claim 10, wherein
mounting the left part of the shearing tip to the right portion of the upper jaw includes mounting the left part of the shearing tip to the upper jaw by a plurality of bolts,
and mounting the right part of the shearing tip to the left portion of the upper jaw includes mounting the right portion of the shearing tip to the upper jaw by a plurality of bolts.

16. The method of claim 15, wherein the left part and the right part define holes for receiving the bolts, and the replaceable shearing tip further includes bushes received in the respective holes and the bolts are received in the respective bushes.

17. The method of claim 16, wherein the bushes are integrated with the left part and right part of the shearing tip.

18. The method of claim 10, wherein
the left part has two symmetrical edges, a mounting section extending between the two symmetrical edges, and a front section connected to the mounting section for covering the front portion of the upper jaw,
and the right part has two symmetrical edges, a mounting section extending between the two symmetrical edges, and a front section connected to the mounting section for covering the front portion of the upper jaw.

19. The method of claim 18, wherein the front section of the right part and the front section of the left part together cover an entire surface of the front portion of the upper jaw.

20. The method of claim 18, wherein the front section of the right part is integrated with the front section of the left part.

21. A shear comprising:
a lower jaw;
an upper jaw pivotally connected to the lower jaw, the upper jaw having a left portion, a right portion, and a front portion between the left portion and the right portion; and
a replaceable shearing tip mounted on the upper jaw, the replaceable shearing tip including:
a left part having two symmetrical edges, a mounting section extending between the two symmetrical edges for mounting the left part on the upper jaw and a front section connected to the mounting section for covering the front portion of the upper jaw; and
a right part having two symmetrical edges, a mounting section extending between the two symmetrical edges for mounting the right part on the upper jaw, and a front section connected to the mounting section for covering the front portion of the upper jaw,
wherein the left part and the right part are interchangeable.

22. The shear of claim 21, wherein the left part and the right part of the replaceable shearing tip are substantially identical.

23. The shear of claim 21 wherein the front section of the right part and the front section of the left part together cover an entire surface of the front portion of the upper jaw.

24. The shear of claim 21, wherein the front section of the right part is integrated with the front section of the left part.

25. The shear of claim 21, wherein the left part and the right part of the replaceable shearing tip are mounted to the upper jaw by a plurality of bolts.

26. The shear of claim 25, wherein the left part and the right part define holes for receiving the bolts, and the holes have respective bushes, and wherein the bolts are received in the respective bushes.

27. The shear of claim 26, wherein the bushes are integrated with the left part and right part of the replaceable shearing tip.

28. A replaceable shearing tip for using with a shear, the shear having a lower jaw and an upper jaw pivotally connected to the lower jaw, the upper jaw having a left portion, a right portion, and a front portion between the left portion and the right portion, the replaceable shearing tip comprising:
a left part having two edges, a mounting section extending between the two edges for mounting the left part on the upper jaw and a front section connected to the mounting section for covering the front portion of the upper jaw; and
a right part having two edges, a mounting section extending between the two edges for mounting the right part on the upper jaw, and a front section connected to the mounting section for covering the front portion of the upper jaw,
wherein the left part and the right part include holes, and the replaceable shearing tip further includes bushes received in the respective holes, and the replaceable shearing tip further includes bolts received in the respective bushes, and
wherein the left part and the right part of the replaceable shearing tip are mounted to the upper jaw by the bolts.

29. The replaceable shearing tip of claim 28, wherein the bushes are integrated with the left part and right part of the replaceable shearing tip.

30. The replaceable shearing tip of claim 28, wherein the left part and the right part are interchangeable.

31. The replaceable shearing tip of claim 28, wherein the left part and the right part are substantially identical.

32. The replaceable shearing tip of claim 28, wherein the two edges of the left part are symmetrical, and the two edges of the right part are symmetrical.

33. The replaceable shearing tip of claim 28, wherein the front section of the right part and the front section of the left part together cover an entire surface of the front portion of the upper jaw.

34. The replaceable shearing tip of claim 28, wherein the front section of the right part is integrated with the front section of the left part.
